(19) United States
(12) Patent Application Publication
(10) Pub. No.: US 2010/0104059 A1
(43) Pub. Date: Apr. 29, 2010

(54) RENORMALIZATION METHOD OF EXCORE DETECTOR

(75) Inventors: Moon Ghu Park, Daejeon (KR); Ho Cheol Shin, Daejeon (KR); Yong Hee Kim, Daejeon (KR)

Correspondence Address: MARTINE PENILLA & GENCARELLA, LLP, 710 LAKEWAY DRIVE, SUITE 200, SUNNYVALE, CA, 94085, US

(73) Assignee: Korea Electric Power Corporation, a Korean Corporation, Seoul (KR)

(21) Appl. No.: 12/345,530

(22) Filed: Dec. 29, 2008

(30) Foreign Application Priority Data
Oct. 29, 2008 (KR) 2008-0106476

(51) Int. Cl. G21C 17/00

(52) U.S. Cl. 376/245

(57) ABSTRACT

Disclosed is a calibration method of an excore detector used in core power monitoring of a nuclear power plant, in which a spatial weighting function (SWF), used to theoretically predict a signal of the excore detector is multiplied by a designated calibration factor to reflect characteristics of the excore detector in a calibration process. It is assumed that the SWF is the multiplication of a one-dimensional shape annealing function (SAF) and a two-dimensional SWF, and the SAF is multiplied by the calibration factor. Since the SAF is calculated in a normalized form, the multiplication of the SAF by the calibration factor to reflect characteristics of the excore detector corresponds to new normalization and thus the calibration of the SAF is referred to as renormalization The signal of the excore detector is considerably accurately predicted by multiplying the theoretically calculated SAF by the renormalization factor, and the multiplication is equally applied although the characteristics of the excore detector are highly changed. An increase in the accuracy of the excore detector in the nuclear power plant prevents unnecessary reactor trips and allows a reactor to be operated at a stable power, thus obtaining the safety of a core and raising economical efficiency.

### BACKGROUND OF THE INVENTION

1. Field of the Invention

The present invention relates to a calibration method of an excore detector used in core power monitoring of a nuclear power plant, and more particularly to an advanced calibration method of an excore detector, which is a part of a core power distribution measurement system to maintain nuclear fuel integrity, i.e., the minimum requirement in the safe operation of a nuclear power plant.

2. Description of the Related Art

Power distributions in a core include a power distribution in a radial direction and a power distribution in an axial direction. The radial power distribution is determined at a design stage according to a nuclear fuel assembly-loaded model including a proper distribution of burnable absorber rods, but the axial power distribution is difficult to control due to xenon transition and thus a nuclear power plant sets up an allowable operation region for the axial power distribution to maintain nuclear fuel integrity. That is, as the allowable operation region is restricted to the deviation range of the axial power, the accuracy of an excore detector is important and thus the maintenance of the reliability of measurement is very important.

FIG. 1A is a plan view illustrating a nuclear reactor and excore detectors of a Korean standard nuclear power plant, and FIG. 1B is an elevation view illustrating a nuclear reactor and a three-channel excore detector of OPR-1000. As shown in FIGS. 1A and 1B, the excore detectors are installed within a cavity wall under the condition that a barrel is interposed between the nuclear reactor and the excore detectors. Further, FIG. 2 is a simple view illustrating excore detectors of a nuclear power plant. FIG. 2 illustrates an example, in which excore detectors 22 are installed around a nuclear reactor 20.

In the Korean standard nuclear power plant, excore detectors of three kinds, i.e., an Safety channel excore detector, a control channel excore detector, and a startup channel excore detector, are installed at the outside of a nuclear reactor vessel. Among the three channel excore detectors, the safety channel excore detector includes four independent channels, and each of the four independent channels includes three sub-channels, i.e., top (TOP), middle (MID), and bottom (BOT) sub-channels. The signal of the safety channel excore detector is used as an input of a core protection calculator (CPC), which is a core protection system, to determine a power and a power distribution of the core, and thus is periodically calibrated according to a related procedure.

The theoretical prediction of the signal of an excore detector of a nuclear power plant uses the concept of a spatial weighting function (SWF). In case that a three-dimensional power distribution in a core is referred to as P(r), a signal R of the excore detector can be calculated by the expression (1) below.

R=∫_{V}P(r)ω(r)dr Expression (1)

Here, ω(r) means an SWF of the excore detector, and V means a volume of the core. When the SWF of the excore detector is known, it is possible to calculate the signal of the excore detector in any power distributions. The SWF of the excore detector is determined through several methods. Generally, the SWF of the excore detector is effectively determined using the adjoint flux of a neutron transport equation, such as the expression (2) below.

L^{†}Φ^{†}(r,Ω,E)+Σ_{d}(r,Ω,E)=0 Expression (2)

Here, L^{†} means an adjoint transport operator (ATO) in a normal state, and Σ_{d}(r,Ω,E) means a sectional area of the excore detector.

In order to calculate the accurate SWF of the excore detector, the expression (2) needs to be solved for a three-dimensional core. However, since the three-dimensional neutron transport calculation requires an excessive calculation time, a method of combining a two-dimensional SWF and a one-dimensional SWF is generally used to predict the signal of the excore detector. The combination method of the two-dimensional SWF and the one-dimensional SWF is carried out on the assumption that the three-dimensional SWF fundamentally satisfies the expression (3) below.

ω(r)=ω_{XY}(x,y)ω_{Z}(z) Expression (3)

In the expression (3) above, the two-dimensional SWF ω_{XY}(x,y) is used as the concept of an assembly weighting factor (AWF), and the one-dimensional SWF ω_{Z}(z) is usually called a shape annealing function (SAF).

In the nuclear design of a core, power distributions are generally expressed in terms of a nuclear fuel assembly as a unit. Therefore, the two-dimensional SWF uses the concept of the AWF, which is calculated in terms of a nuclear fuel assembly as a unit. In order to calculate the AWF, the expression (2) needs to be solved for a radial core structure. Here, a material composition of the core is determined according to a loaded model in a corresponding cycle, and an axially-averaged composition is generally used. FIG. 4 shows SAFs of cores of Yonggwang Nuclear Power Plants (hereinafter, referred to as ‘YGN’) 3 & 4 in cycle 1, and these SAFs are applied to OPR-1000 in all cycles.

The SWF of an excore detector represents a weighting degree, with which neutrons physically generated at a designated position in a core contribute to the signal of the excore detector, and is scarcely influenced by the composite of the core from the characteristic point of view. Therefore, the excore detector is characterized in that the SWF of the excore detector determined for the initial core may be used regardless of cycles unless design characteristics of the core are highly changed and the shape or position of the excore detector is changed. The above characteristics of the SWF of the excore detector are caused by the following reason. The excore detector fundamentally reacts with neutrons leaked from the core. In order to allow the neutrons generated from the core to reach the excore detector located at the outside of a pressure vessel, the neutrons need to have considerably high energy. That is, there is a high probability that fast neutrons will react with the excore detector, and thermal neutrons scarcely reach the excore detector.

Generally, the core is greatly heterogeneous. However, from a viewpoint of fast neutrons having a high contribution to the excore detector, it seems that the core is greatly homogeneous. The reason is that fast neutrons have a high energy and are very insensitive to the heterogeneity of the core of a pressurized water reactor. That is, when the SWF of the excore detector is calculated, there is no necessity for modeling the heterogeneity of the core. On the other hand, the nuclear fuel management of the core of the pressurized water reactor is rarely changed according to cycles. The enrichment degree of nuclear fuel assemblies is slightly changed and nuclear fuel assembly-loaded models are different per cycle, but fast neutrons can scarcely sense these changes. Due to the above physical characteristics, although the SWF of the excore detector is determined for an initial core, the SWF of the excore detector can be used regardless of nuclear fuel cycles. Of course, these characteristics of the SWF are applied to the AWF, which is a two-dimensional SWF.

Although the AWF is not sensitive to core characteristics, such as a nuclear fuel assembly-loaded model, a nuclear fuel burnup, a power, etc., the AWF is slightly influenced by the core characteristics, when the state of the core is comparatively highly changed. For example, when a control group is inserted into the core, a non-ignorable change of the AWF is generated compared with a case that there is no control group in the core.

In order to cause neutrons, coming from a designated position in the core, to the excore detector, the neutrons should penetrate the pressure vessel over various barrels. On the other hand, the mean free path of fast neutrons in the pressured water reactor has a distance of approximately 20-30 cm, which is similar to the size of the nuclear fuel assembly. Thus, there is little probability that neutrons generated from the inside of the core will reach the excore detector. As a result, it is expected that the closer the position of the nuclear fuel assembly is to the excore detector, the larger the value of the AWF is. FIG. 3 significantly shows this characteristic.

An axial power distribution at the outside of the core is obtained by multiplying the AWF, representing the excore detector weighting degree in the radial direction of the core, by a three-dimensional power distribution. In order to predict a signal of the excore detector for this axial power distribution, the SAF representing the contribution to the excore detector according to the axial position of the core needs to be determined. The SAF corresponds to ω_{Z}(z) in the expression (3). The SAF can be obtained by solving the neutron transport equation for the core and the excore detector of FIG. 1. Here, the core is analyzed using a two-dimensional r-z model. The excore detector of OPR-1000 includes three sub-channels, i.e., top (TOP), middle (MID), and bottom (BOT) sub-channels, as shown in FIG. 1, and thus SAFs of the respective sub-channels are obtained. Generally, the signal of the excore detector is insignificant unless the calibration of the signal is achieved. Therefore, the SAFs are calculated in normalized forms of upper, middle, and lower signals. In case that the adjoint flux of the expression (2) is referred to as Φ_{d}^{†}, the SAF of each of the sub-channels of the excore detector is obtained by the expression (4) below.

$${ω}_{d , k} = \frac{\begin{matrix}{\int }_{{V}_{k}}^{ } d {r}_{i} \int \int χ ( E ) \\ {Φ}_{d}^{†} ( {r}_{i} , Ω , E ) d Ω d E\end{matrix}}{\begin{matrix}{\sum }_{d = 1}^{3} {\int }_{V}^{ } d {r}_{i} \int \int χ ( E ) \\ {Φ}_{d}^{†} ( {r}_{i} , Ω , E ) d Ω d E\end{matrix}} \cdot \frac{V}{{V}_{k}} , \\ k = 1 , 2 , … , K \qquad Expression ( 4 )$$

Here, ω_{d,k} means an excore detector weighting degree at the k^{th} node, when the core is divided into k regions in the axial direction. The factor d represents upper, middle, lower sub-channels. In the expression (4), Vₖ means a volume of the k^{th} node in the axial direction.

The SAF, which is an axial SWF, is very insensitive to changes in core characteristics, such as a nuclear fuel assembly-loaded model, a nuclear fuel burnup, and a power level, in the same way as the AWF, and changes of the SAF due to these factors are ignorable. However, the SAF is influenced a little by the power of the core, compared with the AWF. Since the excore detector reacts with fast neutrons, as described above, the heterogeneity of the core cannot influence the SWF so much. However, most fast neutrons generated by nuclear fission in a pressurized water reactor are converted into thermal neutrons by water used as a moderator. Here, the moderating capacity of the moderator is considerably sensitive to the density of water, and thus the temperature of the moderator may greatly influence the moderating capacity. The SAF representing an excore detector weighting degree in the axial direction denotes a distribution of the excore detector weighting degree in the axial direction of the core, and the moderator has a difference of approximately 32° C. between an inlet temperature and an outlet temperature, when the core power is high. That is, the temperature of the moderator at the upper portion of the core is higher than that of the moderator at the lower portion of the core. It means that fast neutrons are more easily thermalized at the lower portion of the core than at the upper portion of the core, and thus the leakage of fast neutrons at the lower portion of the core to the outside of the core is more difficult than at the upper portion of the core. It indicates that a probability of reaching fast neutrons coming from the upper portion of the core to the excore detector located at the outside of the pressure vessel is higher than a probability of reaching fast neutrons coming from the lower portion of the core to the excore detector. Therefore, there is a slight difference between the SAF at a low power level and the SAF at a full power level.

Table 1 shows SAFs of YGN 3 & 4 in cycle 1 at power levels of 20%, 50%, and 100% to represent sensitivity to the core power.

TABLE 1
SAFs (Shapes Annealing Functions) of YGN 3 & 4 in cycle 1

| | SAF (Shape Annealing Functions) | | | | | | | | |
|---|---|---|---|---|---|---|---|---|---|
| Core | 20% Power | | | 50% Power | | | 100% Power | | |
| Height | BOT | MID | TOP | BOT | MID | TOP | BOT | MID | TOP |
| .975 | .0560 | .2301 | 1.8003 | .0564 | .2315 | 1.8115 | .0569 | .2342 | 1.8313 |
| .925 | .0639 | .2805 | 2.1633 | .0642 | .2821 | 2.1748 | .0648 | .2849 | 2.1949 |
| .875 | .0730 | .3655 | 2.4307 | .0734 | .3675 | 2.4425 | .0740 | .3709 | 2.4629 |
| .825 | .0862 | .5135 | 2.5389 | .0866 | .5159 | 2.5497 | .0873 | .5202 | 2.5689 |
| .775 | .1049 | .7399 | 2.4474 | .1053 | .7429 | 2.4564 | .1060 | .7482 | 2.4724 |
| .725 | .1293 | 1.0556 | 2.1604 | .1297 | 1.0590 | 2.1672 | .1304 | 1.0651 | 2.1793 |
| .675 | .1603 | 1.4468 | 1.7562 | .1607 | 1.4503 | 1.7607 | .1615 | 1.4565 | 1.7687 |
| .625 | .2048 | 1.8603 | 1.3327 | .2052 | 1.8634 | 1.3354 | .2058 | 1.8686 | 1.3398 |
| .575 | .2794 | 2.2179 | .9549 | .2797 | 2.2196 | .9561 | .2803 | 2.2228 | .9581 |
| .525 | .4070 | 2.4335 | .6536 | .4071 | 2.4338 | .6540 | .4074 | 2.4342 | .6546 |
| .475 | .6113 | 2.4309 | .4392 | .6110 | 2.4295 | .4391 | .6104 | 2.4264 | .4389 |
| .425 | .9001 | 2.2101 | .3037 | .8989 | 2.2071 | .3034 | .8967 | 2.2017 | .3029 |
| .375 | 1.2634 | 1.8485 | .2227 | 1.2606 | 1.8446 | .2223 | 1.2558 | 1.8380 | .2216 |
| .325 | 1.6686 | 1.4315 | .1729 | 1.6637 | 1.4276 | .1724 | 1.6551 | 1.4208 | .1716 |
| .275 | 2.0471 | 1.0368 | .1368 | 2.0396 | 1.0333 | .1363 | 2.0267 | 1.0271 | .1355 |
| .225 | 2.2930 | .7156 | .1071 | 2.2833 | .7128 | .1067 | 2.2662 | .7077 | .1059 |
| .175 | 2.3250 | .4799 | .0829 | 2.3140 | .4777 | .0825 | 2.2944 | .4738 | .0818 |
| .125 | 2.1486 | .3198 | .0644 | 2.1374 | .3182 | .0640 | 2.1176 | .3154 | .0635 |
| .075 | 1.8243 | .2235 | .0515 | 1.8141 | .2222 | .0512 | 1.7961 | .2201 | .0507 |
| .025 | 1.4464 | .1697 | .0433 | 1.4377 | .1687 | .0430 | 1.4228 | .1669 | .0426 |

Table 2 shows SAFs of YGN 3 in cycle 1, calculated at the full power level, and represents the influence of a core burnup on the SAFs. Table 2 illustrates that the SAFs are very slightly changed at the beginning of the cycle, the middle of the cycle, and the end of the cycle, and includes changes of SAFs according to a power distribution as well as the influence of the core burnup on the SAFs. Generally, in case of an initial core, a power distribution at the beginning of the cycle and a power distribution at the end of the cycle are considerably different. Consequently, it is appreciated that the sensitivity of the SAFs to the core burnup and the sensitivity of the SAFs to the power distribution is low enough to be ignorable.

TABLE 2
SAFs (Shapes Annealing Functions) of YGN 3 in cycle 1 (full power)

| | SAF (Shape Annealing Functions) | | | | | | | | |
|---|---|---|---|---|---|---|---|---|---|
| Core | 0 MWD/MTU | | | 6,000 MWD/MTU | | | 13,000 MWD/MTU | | |
| Height | BOT | MID | TOP | BOT | MID | TOP | BOT | MID | TOP |
| .975 | .0569 | .2342 | 1.8313 | .0569 | .2339 | 1.8289 | .0569 | .2338 | 1.8286 |
| .925 | .0648 | .2849 | 2.1949 | .0648 | .2844 | 2.1915 | .0647 | .2843 | 2.1905 |
| .875 | .0740 | .3709 | 2.4629 | .0739 | .3701 | 2.4580 | .0738 | .3699 | 2.4566 |
| .825 | .0873 | .5202 | 2.5689 | .0871 | .5188 | 2.5629 | .0870 | .5185 | 2.5612 |
| .775 | .1060 | .7482 | 2.4724 | .1057 | .7461 | 2.4661 | .1057 | .7457 | 2.4648 |
| .725 | .1304 | 1.0651 | 2.1793 | .1301 | 1.0623 | 2.1736 | .1301 | 1.0620 | 2.1729 |
| .675 | .1615 | 1.4565 | 1.7687 | .1611 | 1.4532 | 1.7644 | .1611 | 1.4529 | 1.7641 |
| .625 | .2058 | 1.8686 | 1.3398 | .2054 | 1.8652 | 1.3371 | .2055 | 1.8652 | 1.3371 |
| .575 | .2803 | 2.2228 | .9581 | .2799 | 2.2199 | .9566 | .2800 | 2.2204 | .9568 |
| .525 | .4074 | 2.4342 | .6546 | .4071 | 2.4325 | .6540 | .4072 | 2.4332 | .6542 |
| .475 | .6104 | 2.4264 | .4389 | .6105 | 2.4267 | .4389 | .6107 | 2.4274 | .4390 |
| .425 | .8967 | 2.2017 | .3029 | .8975 | 2.2035 | .3031 | .8978 | 2.2041 | .3032 |
| .375 | 1.2558 | 1.8380 | .2216 | 1.2579 | 1.8407 | .2219 | 1.2583 | 1.8413 | .2220 |
| .325 | 1.6551 | 1.4208 | .1716 | 1.6590 | 1.4238 | .1720 | 1.6595 | 1.4243 | .1721 |
| .275 | 2.0267 | 1.0271 | .1355 | 2.0323 | 1.0299 | .1358 | 2.0329 | 1.0302 | .1359 |
| .225 | 2.2662 | .7077 | .1059 | 2.2731 | .7099 | .1062 | 2.2737 | .7101 | .1063 |
| .175 | 2.2944 | .4738 | .0818 | 2.3014 | .4753 | .0821 | 2.3020 | .4755 | .0821 |
| .125 | 2.1176 | .3154 | .0635 | 2.1238 | .3163 | .0637 | 2.1242 | .3164 | .0637 |
| .075 | 1.7961 | .2201 | .0507 | 1.8010 | .2207 | .0508 | 1.8009 | .2207 | .0508 |
| .025 | 1.4228 | .1669 | .0426 | 1.4263 | .1674 | .0427 | 1.4259 | .1673 | .0427 |

The related art of the technical field of the present invention is condensed into a process of applying the two-dimensional SWF given by FIG. 3 and the SAF to the expression (3) and then calculating a signal of the excore detector through the expression (1) using the expression (3).

### SUMMARY OF THE INVENTION

Therefore, the present invention has been made in view of the above problems, and it is an object of the present invention to provide a calibration method of an excore detector, in which a signal of the excore detector is considerably accurately predicted through the renormalization of an SAF used to process the signal of the excore detector of a nuclear power plant, and thus the accuracy of the excore detector is increased, thereby preventing unnecessary nuclear reactor trips and operating the reactor at a stable power to obtain the safety of a core and raise economical efficiency.

In accordance with the present invention, the above and other objects can be accomplished by the provision of a calibration method of an excore detector in a nuclear power plant, which uses the expression (1) to theoretically predict a signal (R) of the excore detector, including deducing an accurate prediction for a real signal of the excore detector by multiplying a spatial weighting function (SWF), used to theoretically predict the signal of the excore detector, by a designated calibration factor to reflect characteristics of the excore detector in the calibration, wherein the SWF is given as the multiplication of a one-dimensional shape annealing function (SAF) and a two-dimensional SWF; and the deduction of the accurate prediction of the real signal of the excore detector includes renormalizing the SAF by multiplying the SAF by the designated calibration factor, and multiplying the theoretically calculated SAF by a renormalization factor,

R=∫_{V}P(r)ω(r)dr Expression (1)

where, ω(r) means the SWF of the excore detector, and V is the volume of a core.

The renormalized SAF may be represented by the following expression,

ωᵣₑₙ(z)=fᵣₑₙω(z)

where, fᵣₑₙ is the renormalization factor; and

the renormalization factor may be given as the following expression,

$${f}_{ren} = \frac{{R}_{measured}}{{R}_{calculated}}$$

where, R_{measured} is a measured signal of the excore detector, and R_{calculated} is a calculated signal of the excore detector using the non-renormalized SAF.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a schematic plan view illustrating excore detectors of a nuclear power plant;

FIG. 1B is a schematic elevation view illustrating an excore detector of a nuclear power plant;

FIG. 2 is a view illustrating the concept of an excore detector of a nuclear power plant;

FIG. 3 is a view illustrating the disposition of fuels in a core mainly influencing signals of an excore detector; and

FIG. 4 is a shape function graph influencing of the excore detector in the axial direction of the core.

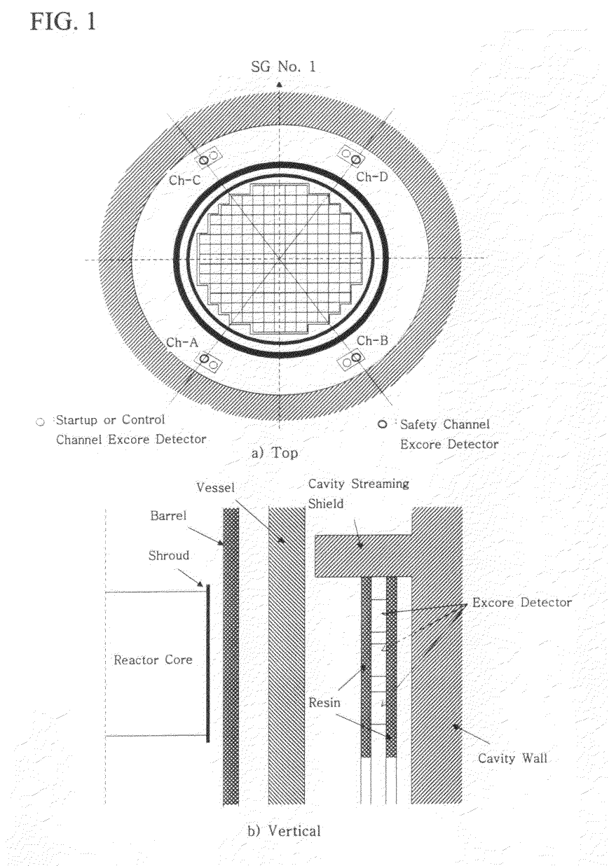

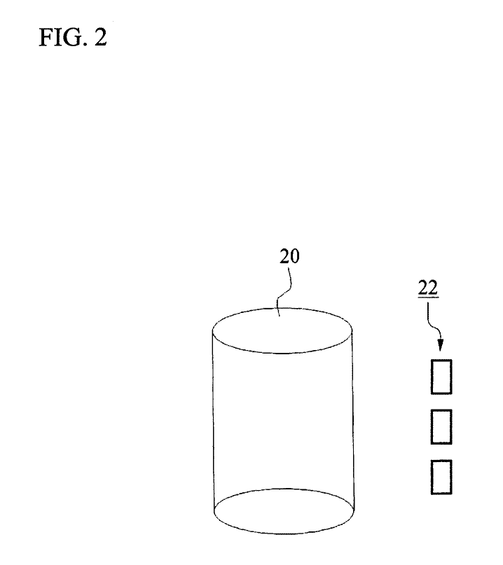

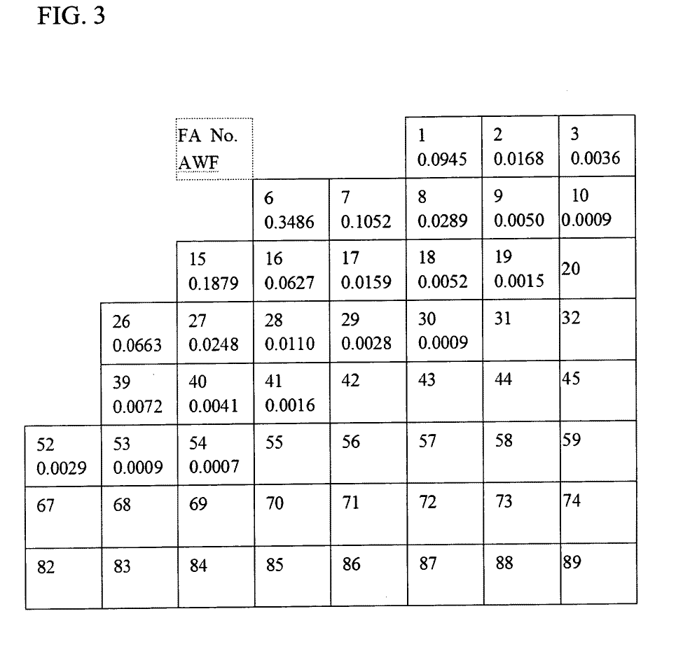

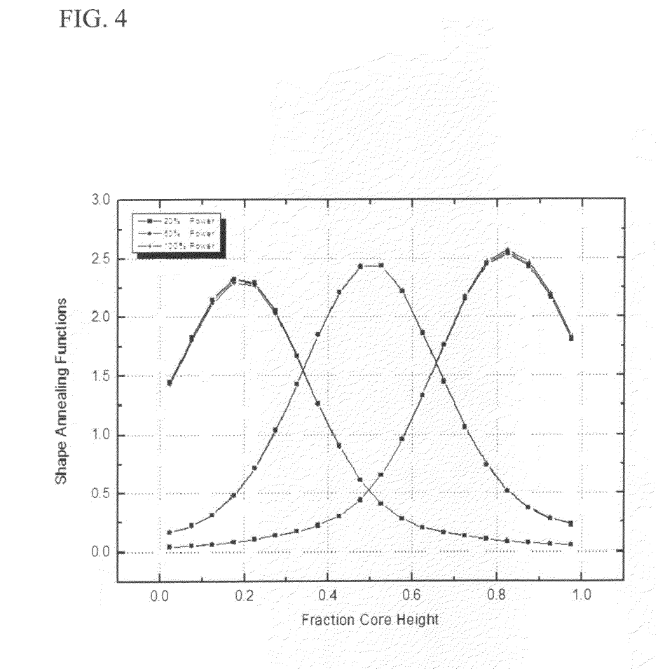

### DESCRIPTION OF THE PREFERRED EMBODIMENTS

Now, a preferred embodiment of the present invention will be described in detail with reference to the annexed drawings.

Although the SWF of an excore detector is accurately calculated, the calculated SWF itself cannot have a practical meaning. The reason is as follows. First, the SWF is calculated on the assumption that top, middle, and bottom sub-channels of the excore detector have the same characteristics. Further, in order to practically use the signal of the excore detector, the calibration of the excore detector is necessarily required. That is, in order to reflect the burnup effect and decalibration effect of the excore detector, the excore detector needs to be periodically calibrated. In case of OPR-1000, the calibration of the power and power distribution of the excore detector is performed per cycle. Therefore, in order to practically use the SWF, the calibration effect of the corresponding excore detector needs to be reflected in the SWF.

The measurement through the excore detector is based on current generated by the reaction of neutrons, which reaches the excore detector through a pressure vessel of a nuclear reactor, with the excore detector. When the size of the current is changed according to the basic characteristics of the excore detector, the current passes through an amplifier and is converted into a practical signal, and the practical signal is used in a core protection calculator. Consequently, the signal of the excore detector, which is practically used, is a signal passed through the amplifier, and the resistance of the amplifier is adjusted such that the signal coincides with a reference signal. That is, the calibration of the excore detector is the adjustment of the resistance of the amplifier, and this adjustment is a linear adjustment from the characteristic aspect of a current circuit. It means that the calibration effect of the excore detector may be reflected in a simulated calculation by the linear adjustment of the SWF.

In the present invention, it is assumed that the SWF is a multiplication of the one-dimensional SWF, i.e., an SAF, and the two-dimensional SWF, i.e., an AWF. Therefore, a calibration factor of the SWF may be reflected in one out of the SAF and the AWF. Here, the calibration factor is applied to the SAF. Generally, the SAF is generally calculated in a normalized form, as described above. Therefore, the multiplication of the SAF by the calibration factor to reflect the characteristics of the excore detector corresponds to new normalization. On this account, the calibration of the SAF is referred to as renormalization. The renormalized SAF is represented by the expression (5) below.

ωᵣₑₙ(z)=fᵣₑₙω(z) Expression (5)

Here, fᵣₑₙ is a renormalization factor.

In order to renormalize the SAF, one reference measurement data is required. This reference measurement data includes a three-dimensional core power distribution and signals of top, middle, and bottom sub-channels of the excore detector at this power distribution. When the reference measurement data is given, the renormalization factor is determined by the expression (6) below.

$${f}_{ren} = \frac{{R}_{measured}}{{R}_{calculated}} \qquad Expression ( 6 )$$

Here, R_{measured} is a measured signal of the excore detector, and R_{calculated} is a calculated signal of the excore detector using the non-renormalized SAF. When the SAF of the expression (5), to which the renormalization factor determined by the expression (6) is applied, is used, the signal of the excore detector for the reference three-dimensional power contribution can be accurately reproduced. Therefore, if the characteristics of the excore detector are maintained, the renormalized SAF is used to predict the signal of the excore detector within an error including only uncertainty of the SAF itself.

It was verified that the sensitivity of the SWF, i.e., the spatial weighting function of the excore detector, to the core burnup and the power distribution is low enough to be ignorable but the SWF is slightly influenced by the power. Therefore, in the present invention, it is assumed that the AWF has the same value on any conditions and the SAF depends only on the power. In order to evaluate the feasibility on the application of the renormalized SAF, the renormalized SAF was applied to YGN 3 in cycle 1 and cycle 2.

Table 3 shows results of the application of renormalized SAFs to a core protection calculator channel A of YGN 3 in cycle 1. Here, SAFs according to power levels were used. (Results of the application of the renormalized SAFs to channels B, C, and D are the same as those of the renormalized SAFs to the channel A).

TABLE 3
SAF renormalization of YGN 3 in cycle 1 (channel A)

| Burnup, | | | Calculated | | Renormalized | Renormalized |
|---|---|---|---|---|---|---|
| MWD/T | | Measured | Signal | | Signals(1) | Signals(2) |
| [Power Level] | Detector | Signal | (Error, %) | fᵣₑₙ | (Error, %) | (Error, %) |
| 126 | TOP | 0.2929 | 0.3011(−2.80) | 0.9728 | 0.2929(0.00) | 0.2947(−0.61) |
| [20%] | MID | 0.4257 | 0.4143(+2.68) | 1.0275 | 0.4254(+0.07) | 0.4253(+0.08) |
| | BOT | 0.2814 | 0.2846(−1.14) | 0.9888 | 0.2817(−0.10) | 0.2799(+0.52) |
| 542 | TOP | 0.2875 | 0.2943(−2.37) | 0.9769 | 0.2874(+0.04) | 0.2883(−0.28) |
| [50%] | MID | 0.4244 | 0.4153(+2.15) | 1.0219 | 0.4240(+0.09) | 0.4240(+0.09) |
| | BOT | 0.2880 | 0.2905(−0.87) | 0.9914 | 0.2886(−0.20) | 0.2877(+0.11) |
| 1421(3) | TOP | 0.2889 | 0.2931(−1.70) | 0.9833 | 0.2884(+0.16) | 0.2884(+0.16) |
| [80%] | MID | 0.4236 | 0.4163(+2.02) | 1.0210 | 0.4235(+0.01) | 0.4235(+0.01) |
| | BOT | 0.2875 | 0.2906(−1.29) | 0.9873 | 0.2880(−0.18) | 0.2880(−0.18) |
| 2000 | TOP | 0.2888 | 0.2933(−1.56) | 0.9847 | 0.2890(−0.06) | 0.2874(+0.48) |
| [100%] | MID | 0.4242 | 0.4152(+2.12) | 1.0217 | 0.4239(+0.08) | 0.4238(+0.10) |
| | BOT | 0.2870 | 0.2916(−1.60) | 0.9842 | 0.2871(−0.05) | 0.2888(−0.62) |
| 5200 | TOP | 0.3032 | 0.3108(−2.51) | 0.9756 | 0.3035(−0.09) | 0.3018(+0.48) |
| [100%] | MID | 0.4054 | 0.3948(+2.61) | 1.0269 | 0.4050(+0.09) | 0.4049(+0.11) |
| | BOT | 0.2914 | 0.2944(−1.03) | 0.9898 | 0.2915(−0.04) | 0.2933(−0.65) |
| 13650 | TOP | 0.3225 | 0.3303(−2.42) | 0.9764 | 0.3227(−0.07) | 0.3208(+0.54) |
| [100%] | MID | 0.3796 | 0.3691(+2.77) | 1.0285 | 0.3792(+0.10) | 0.3792(+0.11) |
| | BOT | 0.2979 | 0.3006(−0.91) | 0.9910 | 0.2981(−0.06) | 0.3001(−0.72) |

(1)power-dependent axial spatial weighting functions
(2)power-independent axial weighting functions
(3)reference measurement data

Table 4 shows results of the application of renormalized SAFs to a core protection calculator channel A of YGN 3 in cycle 2. Here, the same SAFs were used regardless of power levels, but the accuracy in Table 4 do not differ much from that in Table 3.

TABLE 4
SAF renormalization of YGN 3 in cycle 2 (full power, channel A)

| Burnup, | | | Calculated | | Renormalized |
|---|---|---|---|---|---|
| MWD/T | | Measured | Signal | | Signals(1) |
| [Power Level] | Detector | Signal | (Error, %) | fᵣₑₙ | (Error, %) |
| 89(2) | TOP | 0.3606 | 0.3602(−0.11) | 1.0011 | 0.3603(+0.08) |
| [80%] | MID | 0.3869 | 0.3813(−1.45) | 1.0147 | 0.3864(+0.13) |
| | BOT | 0.2525 | 0.2586(+2.42) | 0.9764 | 0.2533(−0.30) |
| 974 | TOP | 0.3399 | 0.3349(−1.47) | 1.0149 | 0.3383(+0.48) |
| [100%] | MID | 0.3865 | 0.3811(−1.40) | 1.0142 | 0.3861(+0.09) |
| | BOT | 0.2736 | 0.2839(+3.76) | 0.9637 | 0.2756(−0.72) |
| 5242 | TOP | 0.3325 | 0.3269(−1.68) | 1.0171 | 0.3308(+0.52) |
| [100%] | MID | 0.3846 | 0.3785(−1.59) | 1.0161 | 0.3843(+0.08) |
| | BOT | 0.2829 | 0.2946(+4.14) | 0.9603 | 0.2849(−0.70) |
| 10108 | TOP | 0.3371 | 0.3328(−1.28) | 1.0129 | 0.3353(+0.52) |
| [100%] | MID | 0.3786 | 0.3713(−1.93) | 1.0197 | 0.3783(+0.07) |
| | BOT | 0.2842 | 0.2960(+4.15) | 0.9601 | 0.2863(−0.74) |

(1)power-independent axial spatial weighting functions
(2)reference measurement data

In Tables 3 and 4, the renormalization factor was determined at the beginning of the cycle, and this factor was applied to all burnups. It is verified that although the renormalization factor determined at the beginning of the cycle is applied, as the results shown in Tables 3 and 4, the error of the simulated signal of the excore detector at the end of the cycle is very low. Particularly, in case of cycle 1, in which the axial power distribution is severely changed according to the core burnup, it is verified that the error of the predicted signal of the excore detector at the end of the cycle is very low. Cycle 2 having a cycle length of 10,180 MWD/MTU corresponds to a relatively short cycle. Therefore, the change in the power distribution according to the burnup in cycle 2 is not so high. On this account, the accuracy of the signal of the excore detector, which is predicted using the renormalized SAF, is very high. These results are equal in all the channels. Therefore, it is verified that the renormalized SAF is used to predict the signal of the excore detector with sufficient accuracy.

It is verified that when the renormalization factor is applied to the theoretically calculated SAF, the practical signal of the excore detector is considerably accurately predicted. This fact is equal even if the characteristics of the excore detector are greatly changed.

As described above, the present invention is capable of achieving the following effects. It is verified that when the renormalization factor is applied to the theoretically calculated SAF, the practical signal of the excore detector is considerably accurately predicted. This fact is equal even if the characteristics of the excore detector are greatly changed. The reason is that the calibration of the excore detector fundamentally has a linear influence on the SAF. The signal of the excore detector is one of inputs of a reactor protection system. When the accuracy of the signal of the excore detector is not maintained, the signal of the excore detector causes a difficulty in securing the safety of a nuclear reactor and unnecessary reactor trips, and thus generates a serious economic loss. Particularly, since it is very important to accurately trace/monitor changes in operating conditions of a nuclear reactor, such as the use of a conservative trip set point due to the use of newly developed nuclear fuel, the deepening of a power distribution change due to the increase of an operation cycle, etc., it is inferred that the effect of the present invention on the safety operation of the nuclear reactor is great. (Actually, there were many cases of reactor trips and power cutbacks of a reactor due to a decrease in the accuracy of the signal of an excore detector.)

The subject matter of the present invention is to considerably accurately predict the signal of an excore detector by multiplying the theoretically calculated SAF by the renormalization factor, and this multiplication is equally applied although the characteristics of the excore detector are highly changed. An increase in the accuracy of the excore detector in a nuclear power plant prevents unnecessary reactor trips and allows a reactor to be operated at a stable power, thus obtaining the safety of a core and raising economical efficiency.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A calibration method of an excore detector in a nuclear power plant, which uses the expression (1) to theoretically predict a signal (R) of the excore detector, comprising deducing an accurate prediction for a real signal of the excore detector by multiplying a spatial weighting function (SWF), used to theoretically predict the signal of the excore detector, by a designated calibration factor to reflect characteristics of the excore detector in the calibration, wherein:
the SWF is given as the multiplication of a one-dimensional shape annealing function (SAF) and a two-dimensional SWF; and
the deduction of the accurate prediction of the real signal of the excore detector includes renormalizing the SAF by multiplying the SAF by the designated calibration factor, and multiplying the theoretically calculated SAF by a renormalization factor,
R=∫_{V}P(r)ω(r)dr Expression (1)
where, ω(r) means the SWF of the excore detector, and V is the volume of a core.

2. The calibration method according to claim 1, wherein:
the renormalized SAF is represented by the following expression,
ωᵣₑₙ(z)=fᵣₑₙω(z)
where, fᵣₑₙ is the renormalization factor; and
the renormalization factor is given as the following expression,
$${f}_{ren} = \frac{{R}_{measured}}{{R}_{calculated}}$$
where, R_{measured} is a measured signal of the excore detector, and R_{calculated} is a calculated signal of the excore detector using the non-renormalized SAF.
